(19) United States
(12) Patent Application Publication
(10) Pub. No.: US 2001/0037368 A1
(43) Pub. Date: Nov. 1, 2001

(54) Network request-response virtual-direct interaction to facilitate direct real-time transaction communications

(76) Inventor: Bin Huang, Fremont, CA (US)

Correspondence Address: Bo-In Lin, 13445 Mandoli Drive, Los Altos Hills, CA, 94022, US

(21) Appl. No.: 09/826,345

(22) Filed: Apr. 4, 2001

Related U.S. Application Data
(60) Provisional application No. 60/194,675, filed on Apr. 4, 2000.

(51) Int. Cl. G06F 15/16

(52) U.S. Cl. 709/204

(57) ABSTRACT

The present invention discloses an Internet system. The Internet system includes an electronic-commerce (e-commerce) engine that has a master server networked (connected through Internet) to a store manager personal computer (PC) and an e-commerce customer. The master server further has a redirection means for redirecting a data received from the e-commerce customer to the store manager PC, or redirecting a feedback data received from store manager PC to the e-commerce customer, to enable a real-time on-line communication between the e-commerce customer and the store manager PC. The master server further has a multiple redirection means for redirecting the data received to different store manage PCs according to the request made by client customers. In a preferred embodiment, the e-commerce engine further has a Web page processor for providing Web pages to the e-commerce customer and store manager PC. In another preferred embodiment, the e-commerce engine further has a database for storing good-or-service catalog of the store manager PC for allowing the e-commerce customer to order the good-or-service from the store manager PC. In another preferred embodiment, the e-commerce engine further has a shopping cart which can temporally store the items or item ids selected by customers. In another preferred embodiment, the e-commerce engine further has a store manager PC registration-and log-in/log-out processor for registering and logging in and out the store manager PC.

This Application claims a priority date of Apr. 4,2000 benefited from a previously filed Provisional Patent Application 60/194,675 filed on Apr. 4, 2000 by the Applicant of this Formal Patent Application.

### BACKGROUND OF THE INVENTION

1. Field of the Invention

This invention relates generally to method and apparatus for network communication for carrying out electronic commerce and electronic service activities. More particularly, this invention is related to methods and apparatus for enabling direct network communication between an electronic order-requesting customer and an electronic-order-fulfilling-provider by applying a new technique of network request redirection for effectuating direct real-time on-line transaction communications.

2. Description of the Related Art

Even with current technology for conducting electronic commerce on Internet and more large corporations are now going “on-line” with well publicized Web sites, smaller stores or remote operation units such as warehouses or shipping departments are still not able to enjoy the full benefits of direct real-time on-line transactions. Therefore, a large number of business entities are not able to take full advantage of direct Internet communications to realize the benefits of electronic commerce. The difficulty arises from the fact that smaller shops or operation units do not have sufficient hardware, software or engineering resources to function as a Web site server to communicate directly with an on-line customer by sending Web pages and receiving the data of ordering or inquiries. To setup and maintain Web sites require specific technical expertise. Smaller stores or operational units generally lack such technical resources. External contractors can be employed to setup and maintain the Web sites, but the cost and efforts involved often are not immediately rewarding. For these reasons, smaller stores or operational units, e.g., an off-site warehouse or a repair shop, still face the difficulties that on the one-hand direct communication is desirable and necessary but on the other hand, a cost effective method to develop such capabilities are not readily available.

As vast number of computers now interconnected through Internet and these computers can exchange data and messages through many different kinds of services such as electronic mails and World Wide Web (WWW). The World Wide Web (WWW) is particularly useful for conducting on-line transactions. With the service of the WWW, a server computer system, e.g., a Web server or Web site, is allowed to send graphical Web pages of information to an interconnected client computer system. The Web page is displayed in the client computer system and allowed for the user of the client system to enter data into the data field designated in the Web page. The user of the client system can then send the data requested in Web page back to the Web server or Web site for to further process and complete an ordered transaction according to the data entered. To view a Web page, a user specifies a universal resource locator (URL) in a Hyper Text Transfer Protocol (HTTP) as a request to the Web server. As the Web server receives the request, the Web page is sent to the client's browser and a Web page is displayed on the client's computer.

Most of the Web pages are formed according to a hypertext markup (HTML) language format. A Web page typically includes text together with embedded formatting commands, e.g., tags, which can be used to control the font size, the font style, and other page display options. A Web browser is employed to parse the HTML script in order to display the text in accordance with the specified formats. The HTML can also include another URL for linking to a piece of multimedia data such as a video image or an audio file.

In a conventional configuration for carrying out an electronic commerce transaction, a client connected to the Internet is first linked to a Web server of a corporation selling goods or services on line, e.g., a “home-page” of Dell Computer. A series of Web pages are downloaded from the Web server to the client's computer for the client to make selections and order the goods or services on line to complete an on-line transaction. After receiving the client's order via the main Web server, the order is further transmitted to a warehouse or repair shop via e-mails, facsimile, or other types of communications. A warehouse or repair shop then performs necessary processes to fulfill the order according to the order received. For small operation units such as a warehouse or a repair shop, there is no direct communication between the client and the service or merchandise provider. A requesting client, even sending the request on line, often do not receive a response to the request directly from the service or good provider or even a confirmation of receiving the request from the store manager until next day through e-mail. Unnecessary delay, miscommunications, or misunderstanding often occur due to the lack of direct communication between the order requesting client and the order fulfilling respondent. Quality of communications and timeliness of services or shipment suffer because this indirect configuration in transmitting and managing the on-line orders.

For small business operations, such as a restaurant, gift shops, or shoe stores, drug stores, bookstores, general grocery stores, setting up Web server or Web pages and continuously maintain the server and the Web pages are often beyond their capability. And, an Internet service with broad uploading bandwidth, which is necessary for client customers to review the store or service catalogs, is quite expensive. There are special Internet Web-server such as www.Opentable.com and www.foodline.com providing centralized and dedicated services for making restaurant reservations. However, there is no direct real-time online communication between the Internet clients with the order-fulfilling respondents, e.g., a restaurant. A separate communication is required between the Web servers and the provider of goods and services concerning the client's order. Problems and difficulties arising from indirect communications again hinder effective and timely services or production and delivery of goods requested through on-line orders. An example of such difficulty may be clearly illustrated when a customer makes an order for home delivery of pizza through a centralized Web server to a pizza restaurant. Since there is no direct communication between the pizza restaurant and the person order the home delivery, a person who made such an order does not have a direct confirmation from the restaurant. The customer has no assurance directly provided by the restaurant that the ordered pizza will be delivered at a certain time unless a separate phone call is made to the restaurant. The centralized Web server may confirm a time for delivery. However, the confirmation may be based on unrealistic assumptions of the operation conditions of the pizza restaurant unknown to the Web server.

Therefore, a still need exists in the art of electronic commerce to provide apparatuses and methods to enable a direct communication between an on-line customer and a order-fulfilling provider to fulfill an Internet order. The apparatuses and methods must be simple, easy and economical to use for small business and people without sophisticate computer skills and software and hardware expertise such that problems caused by current indirect configuration can be minimized.

### SUMMARY OF THE PRESENT INVENTION

It is therefore an object of the present invention to provide new and improved system configuration and network communication methods to facilitate direct real-time on-line communication between customer and a direct resource that is able to fulfill the request transmitted through network communication. An Internet resource request-response interaction center is established to facilitate real time interaction between a resource, e.g., goods-or-service, requester and a direct resource provider to eliminate the problem caused by indirect message and information transmissions.

Specifically, it is an object of the present invention to provide an Internet request-response interaction center to facilitate direct interaction between a requester, sending out a request for requesting goods or services, and a direct goods-or-services provider, sends out a response in responding to the request. Applying a stream-socket technology offered in Java for connecting processes, a “virtual-direct” communication is established between the requester and the respondent. The difficulties arising from indirect communication can therefore be resolved.

Briefly, in a preferred embodiment, the present invention discloses an Internet system. The Internet system includes a central electronic-commerce (e-commerce) server with an electronic-commerce (e-commerce) engine that has a master server networked or connected through Internet to a store manager personal computer (PC) and an e-commerce customer. The master server further has a redirection means for redirecting a data of ordering or inquiries received from the e-commerce customer to the store manager PC. The redirection means may also redirect the confirmation or delivery information data from the store manager PC back to the e-commerce customer with the same stream socket connection, to enable a real-time on-line communication between the e-commerce customer and the store manager PC. In a preferred embodiment, the e-commerce engine further has a Web page processor for providing Web pages to the e-commerce customer. In another preferred embodiment, the e-commerce engine further has a database for storing good-or-service catalog of the store manager PC for allowing the e-commerce customer to order the good-or-service from the store manager PC. In another preferred embodiment, the e-commerce engine further has a shopping cart for temporary holding the merchandise items and/or item Ids selected by customers. In another preferred embodiment, the e-commerce engine further has a store manager PC registration-and login/log-out processor for registering and logging in and out the store manager PC. The log-in/log-out process enables the central e-commerce server to obtain store manager PC's IP address and flexibility for stores to use dynamic IP address. In another preferred embodiment, the e-commerce engine further has a capability of handling multiple orders from different client customers at same time and redirecting the transaction data to different store manager PC according to customer's request. Such an Internet system is efficient and economical because many different stores can share a same central e-commerce server with the e-commerce engine described hereby.

In summary this invention discloses a method for receiving and responding an electronic commerce message between networked data handling systems. The method includes a step of receiving an electronic-commerce requesting message from a requesting data handling system and generating a virtual-direct interaction by redirecting the electronic commerce requesting message in real time to a networked responding data handling system. In a preferred embodiment, the method further includes a step of receiving and redirecting a response for responding to the electronic commerce requesting message from the respondent data handling system to the requesting data handling system for providing the virtual-direct interaction between the requesting data handling system and the respondent data handling system.

In essence, a network system for generating a virtual-direct interaction between a net-requester for a good-or-service and a direct-resource for providing the good-or-service is disclosed in this invention. The network system includes a process instantiating means for instantiating a receiving process and a transmitting process for receiving and transmitting requests and a responses. The network system further includes a communication socket means for channeling each of responses to a corresponding request. The communication socket means enables a net-requester for good-and-service and the direct-resource for providing the good-or-service to have a virtual-direct interaction for conducting a real-time interactive communication on the network system. Such network system can handle multiple requests and redirect the requests to different store manager PCs with the multiple thread technology of JAVA.

These and other objects and advantages of the present invention will no doubt become obvious to those of ordinary skill in the art after having read the following detailed description of the preferred embodiment which is illustrated in the various drawing figures.

### BRIEF DESCRIPTION OF THE DRAWINGS

FIG. 1 is network communication system interconnecting an electronic commerce engine interacting between a net-customer and an on-line store to generate a virtual-direct interactions for conducting e-commerce transactions;

FIG. 2 is an architecture structure of the links between a home pages and Web pages for carrying out different functions performed by the electronic commerce engine of FIG. 1; and

FIG. 3 shows the architecture of a network system where an electronic commerce engine is connected to and applied to redirect requests and responses between multiple clients and resource providers for generating multiple virtual-direct network interactions.

### DETAILED DESCRIPTION OF THE PREFERRED EMBODIMENT

Reference is now made to the above listed Figures for the purpose of describing, in detail, the preferred embodiments of the present invention. The Figures referred to and the accompanying descriptions are provided only as examples of the invention and are not intended in anyway to limit the scope of the claims appended to the detailed description of the embodiment.

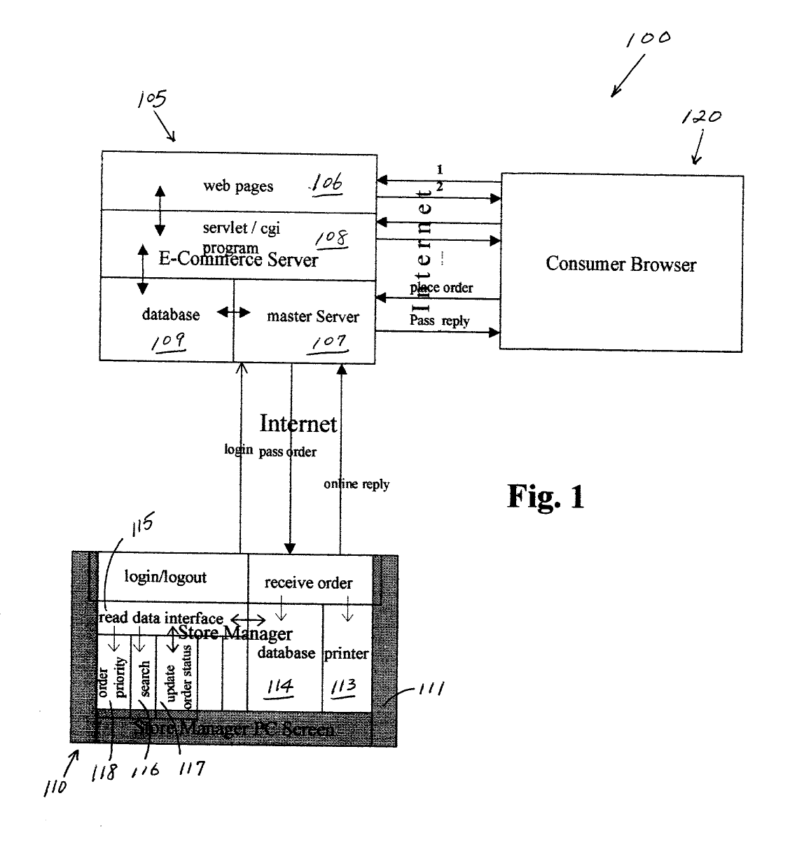

FIG. 1 is a functional block diagram of a network system 100, e.g., an Internet network system, for carrying out electronic commerce thereon. The network system 100 comprises an electronic-commerce server, e.g., an e-commerce engine 105, networked through Internet or Intranet with a store-manager personal computer 110. The e-commerce engine 105 is also networked with a customer who interfaces with the electronic e-commerce engine 105 through a consumer browser 120 that could be a typical Internet browser such as a Microsoft Explorer or Netscape or some other browser. The customer communicates via the consumer browser 120 sending electronic commerce messages to the e-commerce engine 105 through the Internet for ordering services or goods from the store manager 110. The e-commerce engine 105 interface with the customer browser 120 through Web pages 106 executed and controlled by a central e-commerce server 107 running servlet/cgi programs 108 getting data from the database 109. The Web pages, which the e-commerce engine 106 sends to the customer browser 120 include catalogs of goods or services provided by the store 110. The catalogs are stored in the database 109. In reviewing the store catalog, a customer can select items of good or service to temporarily store in the shopping cart provided by the e-commerce engine 105. The customer can then review and verify the selected items and the price listed for each item generated by the shopping cart program for display on the web pages. After verifying the ordering information, the net customer then submits the order for transmitting to the master server 107 of the e-commerce engine 105 through stream socket connection.

Once the e-commerce engine 105 receives a request for ordering goods or services from the store 110 via a stream of data transmitted from the Internet, the e-commerce engine 105 instantiates an incoming order process. As soon as an incoming order process is instantiated, another process is also instantiated for transmitting the order to the store manager 110. The master server 107 also employs a stream-socket technology to establish a second connection for connecting the order transmission process and the incoming order reception process in the store manager PC 110 while the first stream socket connection is still active. A “seamless” communication is therefore established between the customer browser 120 and the store manager 110.

The store manager 110 is typically built on a personal computer (PC) that is provided with a monitor 111 for graphic display and a printer to print out the hard copies of the ordering. The PC 110 is connected to the Internet through an Internet interface module 112 that is provided with order receiving/response means 112-1 and log-in/log-out processor 112-2 to log in and out from the e-commerce engine 105. The orders received through the order receiving/response means 112-1 and transmitted from the Internet are printed on a printer 113 and stored in a database 114. Meanwhile the data transmitted through the order receiving/response means 112-1 is transmitted through a data bus 115 for the PC to process different functions related to the incoming order. Such process may include a search of the database 116 for updating the status of the order 117, for generating order priority 118, and for performing other kinds of store keeping functions such as inventory control, account receivable, etc. A response is also generated from the store manager PC 110 and transmitted to the e-commerce engine 105 through the second stream socket connection established before.

As the master server 107 of e-commerce engine 105 receives the response to the order sent from the store manager PC 110, a response-reception process is generated. Meanwhile, upon receiving the response to order, a response transmission process is generated for sending the response to order to the customer 120 who requests the order through the first stream socket connection as that generated before. Once such two connections are established, a “virtual direct” communication is formed between the responding store manage PC 110 and the requesting customer 120 for exchange information relevant to the order of the services and goods from the store 110.

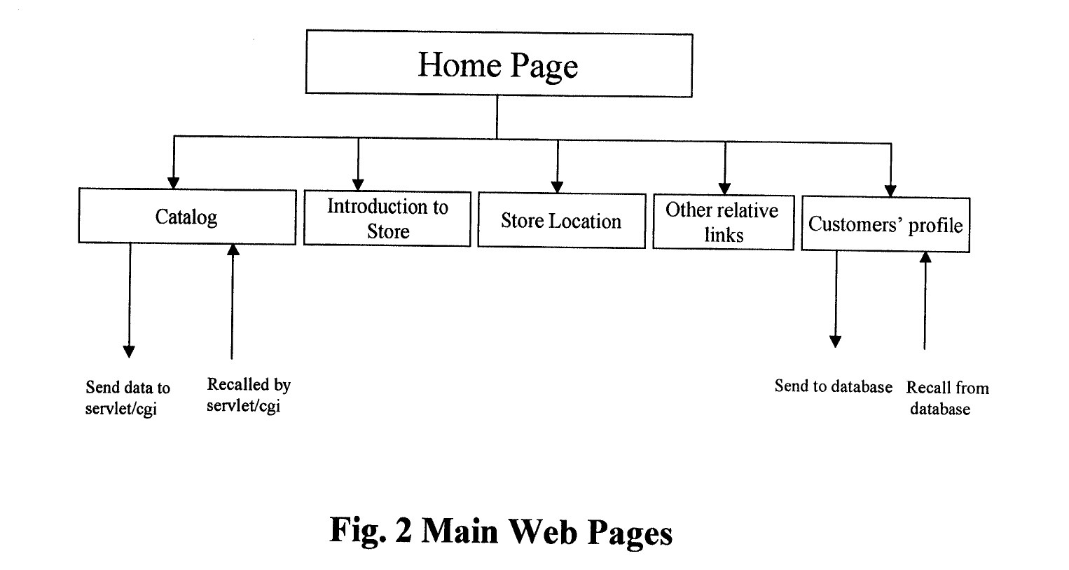

FIG. 2 is an architecture framework of the home page of the e-commerce engine 105. The home page has a link to the introduction to the store and another Web page for showing the store location. For each store, there is a catalog available for an Internet customer to review and make order. Other kinds of links relevant to the e-commerce interactions are also available. Then, for customer to make order goods or services, a customer profile Web page is provided for the customer to enter customer's names and other profile data. A stored customer profile in the database can be retrieved to expedite the ordering process without requiring an old customer to re-enter the same data again.

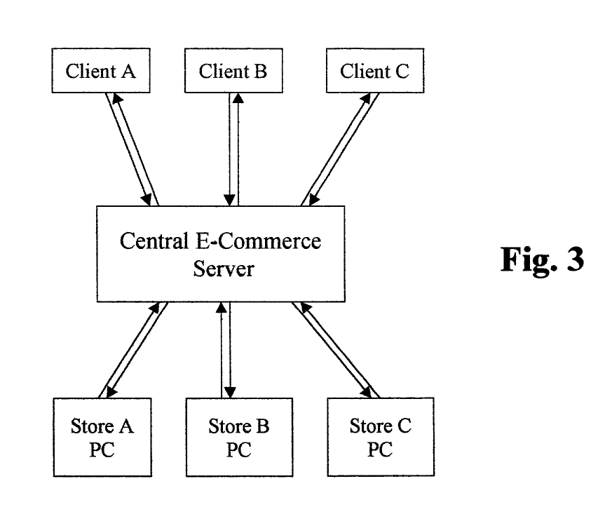

FIG. 3 is an functional block diagram showing the architectural configuration of the interconnections between multiple of net-clients, e.g., clients A, B, and C, logged onto the central e-commerce server. Each of these clients are then carrying out a “virtual-direct” interaction to perform on-line commercial transactions simultaneously with stores, e.g. store A, B, and C personal computers. A JAVA multiple-thread technology allows the central e-commerce server to perform these multiple transactions by redirecting multiple processes as shown in FIG. 3.

According to above description, a method for generating a virtual-direct interaction between a net-requester for a good-or-service and a direct-resource for providing the good-or-service is disclosed in this invention. The method includes the steps of a) instantiating a receiving process for receiving a request from the requester for the good-or-service through an Internet system; b) generating a web page with script containing ordering information for the requester to verify; c) instantiating a connection between a net-requester for a good-or-service and master server of e-commerce engine; d) instantiating a data receiving process for receiving the ordering information from the requester for good-or service; e) instantiating a transmission process for transmitting data to the direct-resource for providing the goods-or-services; and f ) instantiating a second connection for connecting the transmission process with receiving process through Internet for transmitting the request received from the requester through the Internet system to the direct-resource for providing the goods-or-services. In a preferred embodiment, the method further includes steps of g) instantiating a second receiving process for receiving a response from the direct resource for providing the goods-or-services responding to the request through the second connection described in the step f); h) instantiating a second transmission process for transmitting data to the requester for the good-or-service through the first connection established in the step c) for transmitting the response received from the direct-resource for providing the goods-or-services to the requester through the Internet system. In a preferred embodiment, the step c) and f) of connecting the transmission process with the receiving process comprising a step of employing a stream socket for connecting the transmission process with the receiving process. In another preferred embodiment, the step a) of instantiating a receiving process for receiving a request from the requester for the good-or-service through an Internet system further comprising a step of providing an Internet Web page to enable the requester to enter the request for the good-or-service.

In essence, this invention discloses a method for receiving and responding an electronic commerce message between networked data handling systems. The method includes a step of receiving an electronic-commerce requesting message from a requesting data handling system and generating a virtual-direct interaction by redirecting the electronic commerce requesting message in real time to a networked responding data handling system. In a preferred embodiment, the method further comprises a step of receiving and redirecting a response for responding to the electronic commerce-requesting message from the respondent data handling system to the requesting data handling system. This step is to provide the virtual-direct interaction between the requesting data handling system and the respondent data handling system.

In summary, this invention further discloses a network system for generating a virtual-direct interaction between a net-requester for a good-or-service and a direct-resource for providing the good-or-service. The system includes a process instantiating means for instantiating a receiving process and a transmitting process for receiving and transmitting requests and responses. The network system further includes a communication socket means for channeling each of responses to a corresponding request. The communication socket means enables a net-requester for good-and-service and the direct-resource for providing the good-or-service to have a virtual-direct interaction for conducting a real-time interactive communication on the network system. In a preferred embodiment, the process connection means comprising a stream socket connection means for generating steam socket for connecting the transmission process with the receiving process. Such network system can handle multiple requests and redirect the requests to different store manager PCs with the multiple thread technology of JAVA.

The Internet system described above is functionally capable to handle multiple ordering requests and to redirect to different stores with one same e-commerce server with the e-commerce engine described above. Furthermore, the present invention can be employed for all types of applications carried out with the network system described above and the e-commerce/service center which provide network e-commerce services for different types of small business operations. Restaurant, pizza store, bookstore, gift shop, drugstore, grocery store, furniture store, video /movies store and any other stores selling merchandise, with national or local franchise can use a system as disclosed in this invention. The system and configurations disclosed in this invention can also be applied to services requested and reservation made with doctor office, or business appointment, hotel/motel reservation, merchandise warehouse/manufacture site/stockroom, international and/or domestic trading business.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

I claim:

1. An Internet system comprising:
an electronic-commerce (e-commerce) engine comprising a master server Internet connected to a store manager personal computer (PC) and a e-commerce customer; and
said master server comprising a redirection means for redirecting a data received from said e-commerce customer to said store manager PC, and redirecting a responding data received from said store manager PC to said e-commerce customer, to enable a real-time on-line communication between said e-commerce customer and said store manager PC.

2. The Internet system of claim 1 wherein:
said e-commerce engine further comprising a Web page processor for providing Web pages to said e-commerce customer and said store manager PC.

3. The Internet system of claim 1 wherein:
said e-commerce engine further comprising a database for storing good-or-service catalog for said store manager PC for allowing said e-commerce customer to order said good-or-service from said store manager PC.

4. The Internet system of claim 1 wherein:
said e-commerce engine further comprising a shopping cart for temporary storing multiple orders selected by said e-commerce customer for generating a verifying web-page for review and confirmation by said e-commerce customer.

5. The Internet system of claim 1 wherein:
said e-commerce engine further comprising a store manager PC registration-and log-in/log-out processor for registering and logging in and out said store manager PC to obtain a dynamic IP address of said store manager PC.

6. The Internet system of claim 1 wherein:
said master server comprising a multiple thread means for redirecting data received from at least two e-commerce customers to at least two store manager personal computers in parallel.

7. A method for generating a virtual-direct interaction between a net-requester for a good-or-service and a direct-resource for providing said good-or-service comprising:
a) instantiating a receiving process for receiving a request from said requester for said good-or-service through an Internet system; and
b) responding to said request received by said receiving process for instantiating a transmission process for transmitting data to said direct-resource for providing said good-or-service through said Internet system.

8. The method of claim 7 further comprising:
c) instantiating a second receiving process for receiving a response from said direct resource for providing said good-or-service responding to said request;
d) responding to said response from said direct resource for providing said good or service received by said second receiving process for instantiating a second transmission process for transmitting data to said requester for said good-or-service through said Internet system.

9. The method of claim 7 wherein:
said step a) of instantiating said receiving process comprising a step of stream socket connecting a requester transmission process transmitted from said requester to said receiving process instantiated by a master server program; and
said step b) of instantiating said transmission process comprising a step of a second stream socket connecting said transmission process with receiving process instantiated by a said direct-resource program for transmitting data to said direct-resource for providing said goods-or-services through said Internet system.

10. The method of claim 8 wherein:
said step c) of instantiating said second receiving process comprising a step of using said second connection in step b) for transmitting data from said direct-resource transmission process transmitted from said direct-resource to said second receiving process instantiated by a master server program; and
said step d) of instantiating said second transmission process comprising a step of using said connection in step a) for transmitting data to said net requester through said Internet system.

11. The method of claim 6 wherein:
said step a) of instantiating a receiving process for receiving a request from said requester for said good-or-service through an Internet system further comprising a step of providing an Internet Web page to enabling said requester to enter said request for said goods-or-services.

12. A method for receiving and responding an electronic commerce message between networked data handling systems comprising:
receiving an electronic-commerce requesting message from a requesting data handling system and generating a virtual-direct interaction by redirecting said electronic commerce requesting message in real time to a networked responding data handling system.

13. The method of claim 12 further comprising:
receiving and redirecting a response for responding to said electronic commerce requesting message from said respondent data handling system to said requesting data handling system for providing said virtual-direct interaction between said requesting data handling system and said respondent data handling system.

14. A network system for generating a virtual-direct interaction between a net-requester for a good-or-service and a direct-resource for providing said good-or-service comprising:
a process instantiating means for instantiating a receiving process and a transmitting process for receiving and transmitting a request and a response;
a process connecting means for connecting said transmission process with said receiving process for enabling said netrequester for good-and-service and said direct-resource for providing said good-or-service to have a virtual-direct interaction for conducting a real-time interactive communication on said network system.

15. The network system of claim 14 wherein:
said process connection means comprising a stream socket connection means for generating steam socket for connecting said transmission process with said receiving process.

16. The Internet system of claim 1 wherein:
said redirection means redirecting a data relating to a scheduled-reservation received from said e-commerce customer to said store manager PC to enable a real-time online communication between said e-commerce customer and said store manager PC for making said scheduled-reservation for said e-commerce customer.

17. The Internet system of claim 1 wherein:
said redirection means redirecting a data relating to a purchase-merchandise received from said e-commerce customer to said store manager PC to enable a real-time online communication between said e-commerce customer and said store manager PC for completing a transaction of said purchase-merchandise for said e-commerce customer.

18. The Internet system of claim 1 wherein:
said redirection means redirecting a data relating to a price-dependent purchase proposal of a good-or-service received from said e-commerce customer to said store manager PC to enable a real-time on-line communication between said e-commerce customer and said store manager PC for completing a transaction of said price-dependent purchase proposal of a good-or-service for said e-commerce customer.
